(19) United States
(12) Patent Application Publication
(10) Pub. No.: US 2026/0220363 A1
(43) Pub. Date: Jul. 30, 2026

(54) ARTIFICIAL INTELLIGENCE FUNCTION IN SPREADSHEET DOCUMENTS

(71) Applicant: Google LLC, Mountain View, CA (US)

(72) Inventors: Danielle LaBarbiera Jenks, Jersey City, NJ (US); Dmitriy Brezhnev, New York City, NY (US); Matthew Jacob Ziegelbaum, Forest Hills, NY (US); Christopher Mancuso, Wilton, CT (US); Sakhya Ghosh, New York City, NY (US); Eric Birnbaum, Glen Rock, NJ (US); Michael Frederick, Larchmont, NY (US); Juyun Song, New York City, NY (US); Christyn Courtney, Wynnewood, PA (US); Allaire Welk, Brooklyn, NY (US); Sebastian Deri, Oakland, CA (US); Kalonte Jackson-Tate, New York City, NY (US); Jia Guo, Scarsdale, NY (US); Elliott Malkin, Clinton Corners, NY (US); Gustabo Ramirez, New York City, NY (US); Kira Pancha, New York City, NY (US); Marc Anthony Di Meo, Windsor (CA); Anmol Agarwal, Bareilly (IN); Gaye Oncul Kok, Kirkland, WA (US); Samer Roy Sabri, New York City, NY (US)

(21) Appl. No.: 19/041,176

(22) Filed: Jan. 30, 2025

(51) Int. Cl. G06F 40/18; G06F 9/451; G06F 40/40

(52) U.S. Cl. CPC G06F 40/18; G06F 9/451; G06F 40/40

(57) ABSTRACT

Techniques for an artificial intelligence (AI) function in spreadsheet documents is provided herein. A user is provided with access to a spreadsheet document via a user interface (UI). A user query pertaining to an operation associated with an AI model is received based on a user interaction with one or more cells of the spreadsheet document. The UI is updated to include the received user query in the cell(s) and one or more UI elements that enable the user to initiate the operation associated with the AI model. Responsive to a detection of a user interaction with the UI element(s), a prompt associated with the user query is provided as an input to the AI model. One or more outputs of the AI model are obtained, the output(s) including response data pertaining to the user query. The UI is updated to include the response data in the cell(s).

### TECHNICAL FIELD

Aspects and implementations of the present disclosure relate to methods for an artificial intelligence (AI) function in spreadsheet documents.

### BACKGROUND

The development and deployment of artificial intelligence (e.g., large language models (LLMs) has revolutionized various industries by enabling highly sophisticated natural language processing capabilities. Artificial intelligence (AI) models are trained on vast datasets and possess the ability to generate human-like text and provide informative responses to user queries.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 depicts a flow diagram of an example method, in accordance with implementations of the present disclosure.

FIGS. 3A-3B depict an example of AI functionality for a spreadsheet document, in accordance with implementations of the present disclosure.

FIG. 4 is a block diagram illustrating an exemplary computer system, in accordance with implementations of the present disclosure.

### DETAILED DESCRIPTION

Aspects of the present disclosure relate to artificial intelligence (AI) functionalities in spreadsheet documents. A system can provide a user with access to an electronic spreadsheet document (referred to herein as a “spreadsheet document” or a “document”), which enables the user to manage and/or analyze data organized in cells (e.g., via an electronic document application accessed using a client device). Each cell can store different types of data, including numbers, text, dates, and formulas. Manually inputting data into electronic spreadsheet documents can be time-consuming and repetitive. Therefore, it can be difficult to maintain relevant data in such documents. Some systems support functions that automate calculations with respect to data included in cells of spreadsheet documents. In conventional systems, such calculations are automatically performed (e.g., without user initiation) upon entering of the data and/or the calculation formula into the cells of the spreadsheet documents. In documents that include a large amount of data and/or a reference a large number of functions, it can take a large amount of time and/or computing resources (e.g., processing cycles, memory space, etc.) to perform operations associated with such calculation formulas. Such resources may be made unavailable to other processes of the system, which can decrease the overall efficiency and increase the overall latency of the system.

Embodiments of the present disclosure provide AI functionalities for spreadsheet documents, which enable users to keep data fresh and relevant with minimal effort. Embodiments of the present disclosure further enable users to initiate the performance of such AI functionalities. As provided herein, a system or platform (e.g., a collaborative document platform) can provide a user with access to an application associated with an electronic spreadsheet document (e.g., via a user interface (UI) of a client device associated with the user).

In some embodiments, the application can enable users to input user queries into cells of a spreadsheet document specifying a task associated with an AI model. The user query can include a reference to data included in other cells of the spreadsheet document, in some embodiments. Upon detecting that a user has inputted the prompt into the cell, the platform can update a UI of the application associated with the spreadsheet document to include one or more UI elements that enable the user to initiate a performance of one or more operations associated with the AI model. Upon detecting that a user has engaged with the UI element(s), the platform can provide a prompt associated with the user query as an input to the AI model and obtain one or more outputs of the AI model. The output(s) of the AI model can include a response to the user query associated with the prompt. For example, if the user query pertains to summarizing data included in one or more cells of the document, the response to the user query, as obtained based on the output(s) of the AI model, can include the summarization of such data. In some embodiments, the platform may not provide the prompt as the input to the AI model until detecting that the user has engaged with the one or more UI elements.

Upon performance of the operation(s) associated with the user query, the system can update the cell to include the user query response, as obtained based on the output(s) of the AI model. In some embodiments, the user can specify a set of cells of the electronic document that include user queries for which operations are to be performed with operation(s) associated with the prompt. For example, the user can select a range of cells (including across different columns) or discontinuous cells across the spreadsheet document which include user queries associated with the AI model. Upon detecting that the user has engaged with the one or more UI elements to indicate the performance of one or more operations associated with the user queries, the system can provide prompts for each user query of the selected cells as an input and can obtain one or more outputs. The platform can update the selected cells to include the output(s), in some embodiments. In some embodiments, the platform can provide the prompts of the selected cells to the AI model in “batches” (e.g., provide a first portion of the prompts during a first time period and a second portion of the prompts during a second time period). A size of the batch can be determined based on historical data associated with the spreadsheet document or another spreadsheet document associated with the system.

In some instances, the user can update data of a cell that includes the user query associated with the AI model and/or a cell that is referenced by a user query. Upon detecting that the user has updated the data of such cell, the system can update the UI associated with the cell that includes the user query to indicate that the query response, as represented by the cell, is out of date. The platform can provide an updated prompt (e.g., pertaining to the updated data of the cell) as an input to the AI model and can update the cell based on the query response obtained based on the output(s) of the AI model. Additionally or alternatively, the platform can update the UI to remove the indication that the query response is out of date.

As seen above, embodiments of the present disclosure enable a user to access AI functionalities associated with inputting data into cells of a spreadsheet document. Such AI functionalities enable a user to maintain relevant data of the spreadsheet document with minimal effort. Further, embodiments of the present disclosure enable a user to control when a prompt is provided as an input to an AI model and/or which cells for which a prompt is provided as an input to an AI model. Therefore, a significant number of computing resources of a system (e.g., memory space, processing cycles, etc.) are reduced, therefore improving an overall efficiency and latency of the system.

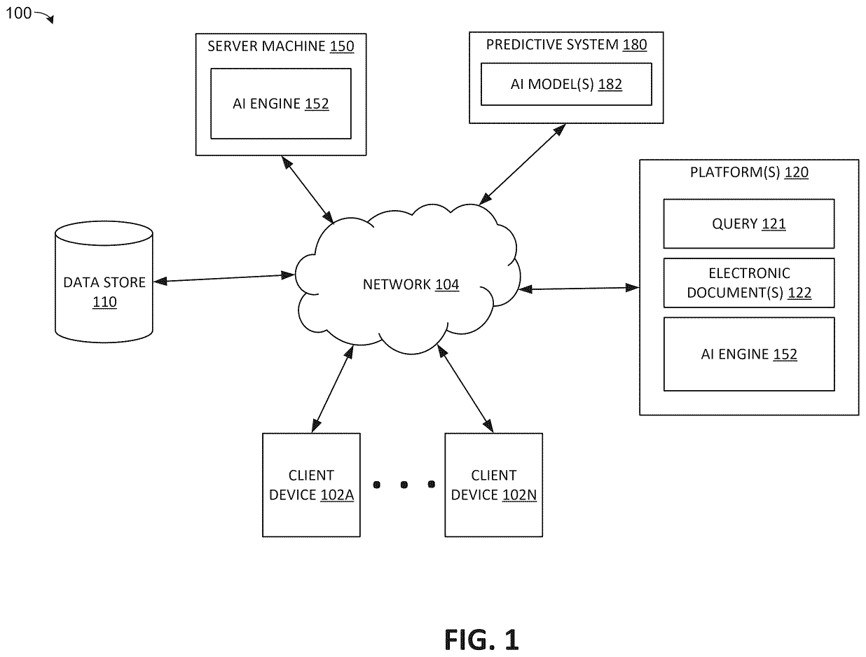

FIG. 1 illustrates an example system architecture 100, in accordance with implementations of the present disclosure. The system architecture 100 (also referred to as “system” herein) includes one or more client devices 102A-N, a data store 110, a platform 120 (e.g., a collaborative document platform, a productivity platform, etc.), one or more server machines (e.g., server machine 150), and/or a predictive system 180, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Data store 110 can be a persistent storage that is capable of storing data as well as data structures to tag, organize, and index the data. Data can include (or include data of) one or more electronic documents and/or metadata associated with the one or more electronic documents. Data store 110 can be hosted by one or more storage devices, such as main memory, magnetic or optical storage based disks, tapes or hard drives, NAS, SAN, and so forth. Data store 110 can be a network-attached file server or can be some other type of persistent storage such as an object-oriented database, a relational database, and so forth, that may be hosted by platform 120 or one or more different machines (e.g., server machine 150) coupled to the platform 120 via network 104.

Client devices 102A-N (collectively and individually referred to as client device(s) 102 herein). can include one or more computing devices such as personal computers (PCs), laptops, mobile phones, smart phones, tablet computers, netbook computers, network-connected televisions, etc. A client device 102 can also be referred to as a “user device.” Client devices 102 can include a content viewer. A content viewer can be an application that provides a user interface (UI) for users to view or upload content, such as images, media items, web pages, documents, etc. The content viewer can render, display, and/or present the content to a user. The content viewer can also include an embedded media player (e.g., a Flash® player or an HTML5 player) that is embedded in a web page (e.g., a web page that may provide information about a product sold by an online merchant). The content viewer can be an electronic document platform application for users to generate, edit, and/or upload content for electronic documents on platform 120.

Platform 120 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to a file (e.g., an electronic document 122) and/or provide the file to the user. For example, platform 120 can be a collaborative document platform or a productivity platform which allows a user to create, edit (e.g., collaboratively with other users), access or share with other users an electronic document stored at data store 110. Platform 120 can also include a website (e.g., a webpage) or application back-end software that can be used to provide a user with access to files.

Functionalities of platform 120 may be supported by one or more AI models 182 provided by predictive system 180. An AI model 182 can be trained to perform multiple types of tasks pertaining to the functionalities of platform 120 and/or files of platform 120. Such tasks include, but are not limited to, content generation, content summarization, content expansion, data classification, knowledge retrieval, and so forth. A user of platform 120 can access the AI model(s) 182 of predictive system 180 via tools or resources of platform 120 (e.g., by providing a query 121 via a user interface (UI) associated with platform 120), as described herein. Predictive system 180 can provide a prompt associated with the query 121 as an input to the AI model(s) 182 and can obtain an output of the model(s). A prompt refers to a natural language text that requests the AI model(s) 182 to perform a specific task. A prompt can include the query 121 provided by the user and/or can include additional or alternative information associated with the query 121. Platform 120 can update the UI provided to the client device 102 to include the generated content for presentation to the user. It should be noted that embodiments of the present disclosure are not limited to the tasks or functions explicitly described herein (e.g., content generation, content summarization, etc.) and embodiments can be applied to any type of task or function that could be performed by an AI model.

AI model 182 can be an AI model that has been trained on a corpus of textual data. AI model 182 can be a model that is first pre-trained on a corpus of text to create a foundational model, and afterwards fine-tuned on more data pertaining to a particular set of tasks to create a more task-specific, or targeted, model. AI model 182 can then be further trained and/or fine-tuned on organizational data, including proprietary organizational data. The second portion of training, including fine-tuning, may be unsupervised, supervised, reinforced, or any other type of training.

AI model 182 may be one or more of decision trees, random forests, support vector machines, or other types of machine learning models. AI model 145 may be one or more artificial neural networks (also referred to simply as a neural network). The artificial neural network may be, for example, a convolutional neural network (CNN) or a deep neural network. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

AI model 182 may be one or more recurrent neural networks (RNNs). An RNN is a type of neural network that includes a memory to enable the neural network to capture temporal dependencies. An RNN is able to learn input-output mappings that depend on both a current input and past inputs. An RNN can include a long short term memory (LSTM) neural network.

As indicated above, the AI model 182 may be one or more generative AI models, allowing for the generation of new and original content. The generative AI model can use other machine learning models including an encoder-decoder architecture including one or more self-attention mechanisms, and one or more feed-forward mechanisms. A generative AI model can also utilize the previously discussed deep learning techniques, including recurrent neural networks (RNNs), convolutional neural networks (CNNs), or transformer networks.

As described above, platform 120 can provide users with access to tools and/or functionalities that enable users to collaborate on electronic documents 122. An electronic document 122 can include a spreadsheet document consisting of a grid of rows and columns, where the intersection of each row and column forms a cell. Each cell can contain data such as numbers, text, formulas, or functions, allowing users to perform calculations, manage information, and generate insights. One or more functions of electronic document 122 can include an AI function. An AI function refers to a function or formula that involves the performance of operation(s) associated with AI model 182. Examples of an operation associated with AI model 182 includes a summarization operation (e.g., to condense content), an expansion operation (e.g., to expand content), a data categorization operation (e.g., to organize or label data into categories or groups), a sentiment analysis operation (e.g., to evaluate the tone of content), a data extraction operation (e.g., to identify and extract specific information from content), a data correction operation (e.g., to identify errors in content and provide corrections to improve accuracy and quality), a translation operation (e.g., to convert content from one language to another), or a calculation operation (e.g., to perform a mathematical or logical computation). As illustrated in FIG. 1, platform 120 can include an AI engine 152, which can facilitate the performance of operations associated with AI model 182. Further details regarding AI engine 152 are provided below.

It should be noted that although some embodiments and examples refer to spreadsheet documents, electronic document 122 can otherwise include word documents, slide presentation documents, webpage documents, messaging documents, and so forth.

It should be noted that although FIG. 1 illustrates update AI engine 152 as part of platform 120, in additional or alternative embodiments, one or more portions or components of AI engine 152 can reside and/or be executed at client device(s) 102 and/or on one or more server machines (e.g., server machine 150) that are remote from platform 120. It should be noted that in some other implementations, the functions of platform 120, server machine 150, and/or predictive system 180 can be provided by more or a fewer number of machines. In addition, in some implementations, components and/or modules of server machine 150, and/or predictive system 180 may be integrated into platform 120 and/or can also be performed on the client devices 102A-N in other implementations.

In implementations of the disclosure, a “user” can be represented as a single individual. However, other implementations of the disclosure encompass a “user” being an entity controlled by a set of users and/or an automated source. Further to the descriptions above, a user may be provided with controls allowing the user to make an election as to both if and when systems, programs, or features described herein may enable collection of user information, and if the user is sent content or communications from a server. In addition, certain data can be treated in one or more ways before it is stored or used, so that personally identifiable information is removed. Thus, the user can have control over what information is collected about the user, how that information is used, and what information is provided to the user.

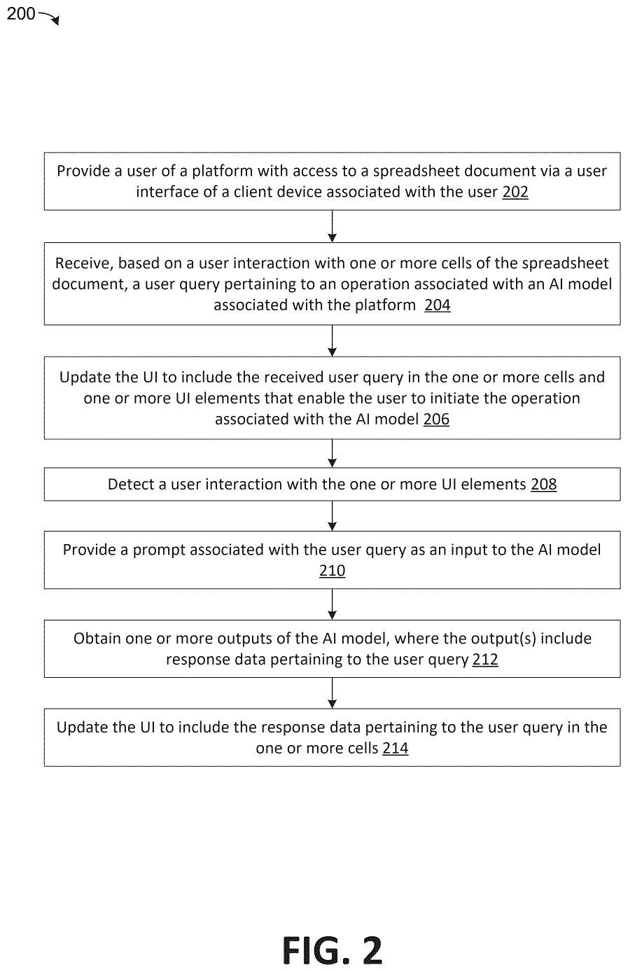

FIG. 2 depicts a flow diagram of an example method 200, in accordance with implementations of the present disclosure. Method 200 can be performed by processing logic that can include hardware (circuitry, dedicated logic, etc.), software (e.g., instructions run on a processing device), or a combination thereof. In one implementation, some or all the operations of method 200 can be performed by one or more components of system 100 of FIG. 1. In some embodiments, some or all of the operations of method 200 can be performed by platform 120.

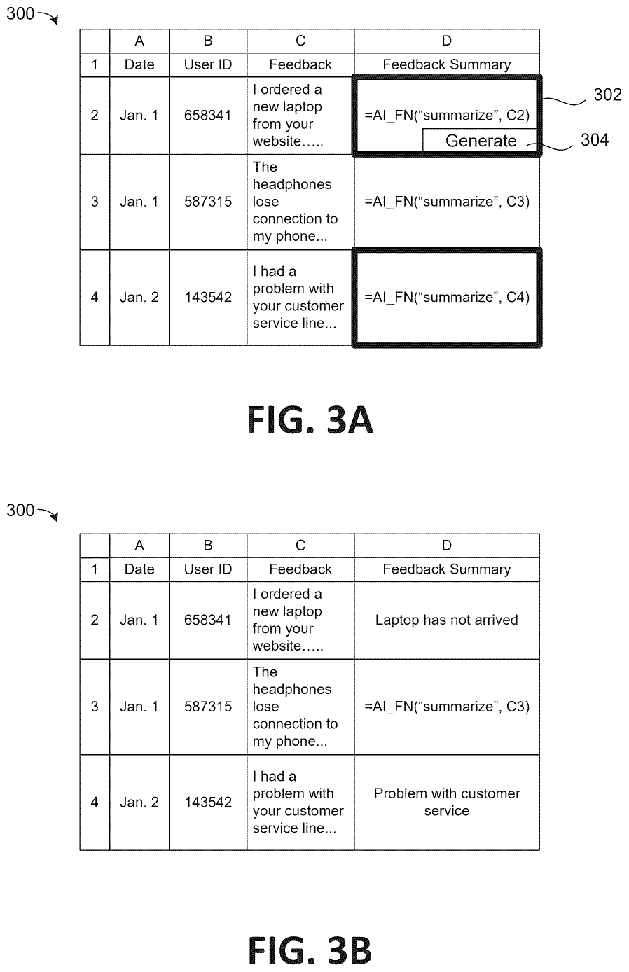

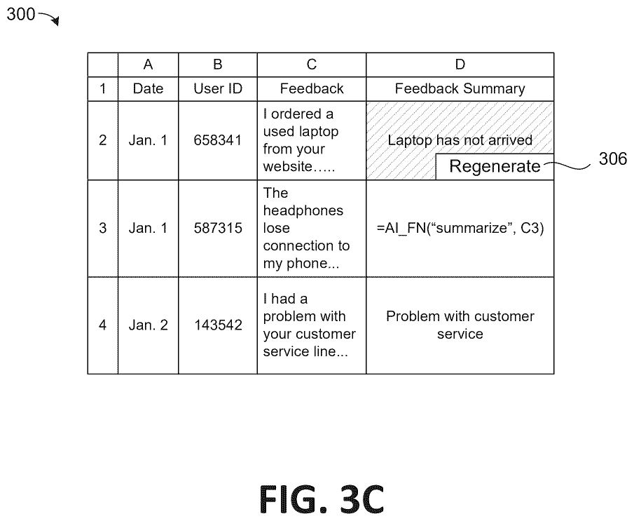

At block 202, processing logic provides a user of a platform with access to a spreadsheet document via a UI of a client device associated with the user. FIG. 3A illustrates an example portion 300 of an electronic document 122. As illustrated by FIG. 3A, electronic document 122 can be a spreadsheet document that includes rows and columns, where the intersection of each row and column makes up a cell 302. Platform 120 can provide the user with access to portion 300 of document 122 in response to a user request received from a client device 102 of the user.

At block 204, processing logic receives, based on a user interaction with one or more cells of the spreadsheet document, a user query pertaining to an operation associated with an AI model associated with the platform. In accordance with the example illustrated by FIG. 3A, cell “D2” of portion 300 can include the value “=AI_FN(“summarize”, C2).” Such value can correspond to a user query to perform a summarization operation with respect to the data included in cell “C2.” The portion of the value that references “AI_FN(. . . )” can be a function call associated with operations of the AI model 182, and the portion of the value that includes “summarize” can indicate a type of operation associated with the AI model 182. It should be noted that such value is provided for the purposes of example and illustration only and that other values can be provided in a cell, which correspond to a user query pertaining to an operation associated with AI model 182. The user may provide the user query into cell 302 via client device 102 and/or a peripheral device of client device 102 (e.g., a mouse, a keyboard, etc.). As illustrated in FIG. 3A, the user may provide the user query in multiple cells 302 (e.g., at cells “D2-D4”). The user can manually select the cells that are to include the user query and/or can provide an indication that the user query is to be included in each cell of column “D” (e.g., by providing the user query into cell “D2” and engaging with one or more UI elements to apply the user query to one or more additional cells of column “D”). As illustrated by FIG. 3A, the value of the user query in cell ““D3” can reference the data of cell “C3,” and the value of the user query in cell “D4” can reference the data of cell “C4.”

At block 206, processing logic updates the UI to include the received user query in the one or more cells and one or more UI elements that enable the user to initiate the operation associated with the AI model. As illustrated by FIG. 3A, platform 120 can update the UI to include a UI element 304 that enables the user to initiate the operation associated with the AI model (e.g., the summarization operation). It should be noted that FIG. 3A illustrates the UI element 304 as located at or near cell “D3.” However, UI element 304 can be located at another region of the UI, in some embodiments. At block 208, processing logic detects a user interaction with the one or more UI elements. The user interaction can include a clicking action, a tapping action, or other such type of engagement action (e.g., provided by the user via the client device 102 and/or the peripheral device of the client device 102).

At block 210, processing logic provides a prompt associated with the user query as an input to the AI model. AI engine 152 (e.g., of or associated with platform 120) can provide the prompt associated with the user query as the input to AI model 182 in response to the detection of the user interaction with UI element 304. AI engine 152 can generate the prompt based on the user query and one or more pre-defined prompt preambles associated with the electronic document 122 and/or an application that supports electronic document 122. In an illustrative example, the generated prompt can include an indication that the user query is associated with a spreadsheet document, the type of operation to be performed (e.g., a summarization operation), and the data (or the location of the data) for which the operation is to be performed (e.g., the data of cell “C2”). The user may select multiple cells 302 for which the operation is to be performed. For example, as illustrated by FIG. 3A, the user may select cell “D2” and cell “D4” for performance of the summarization operation. AI engine 152 can generate the prompt based on the user queries of cells “D2” and “D4,” as described above, and/or may generate multiple prompts (e.g., a first prompt for the query of cell “D2” and a second prompt for the query of cell “D4”).

At block 212, processing logic obtains one or more outputs of the AI model, where the output(s) response data pertaining to the user query. In accordance with the example of FIG. 3A, the output(s) of AI model 182 can include a summarized version of the data included in cell “C2” and/or cell “C4.” Such summarized version(s) can be response data pertaining to the user queries of cell “D2” and/or cell “D4.” At block 214, processing logic updates the UI to include response data pertaining to the user query in the one or more cells. As illustrated by FIG. 3B, platform 120 can update cell “D2” to include the summarized version of the data of cell “C2” (e.g., “Laptop has not arrived”) and/or platform 120 can update cell “D4” to include the summarized version of the data of cell “C4” (e.g., “Problem with customer service”). Platform 120 may not update cell “D3,” as the user did not initiate performance of the operation pertaining to cell “D3,” as described above.

A user may update data included in one or more cells that are referenced by a user query pertaining to an operation associated with AI model 182. For example, as illustrated by FIG. 3C, the user can update the data in cell “C2” from “I ordered a new laptop from your website . . . ” to be “I ordered a used laptop from your website. In response to detecting the update to the data in cell “C2,” platform 120 can update one or more UI elements associated with cell “D2” to indicate that the response to the user query of cell “D2” is out of date (e.g., as illustrated by FIG. 3C). Platform 120 can update the UI to include another UI element 306 that enables the user to re-initiate the performance of the operation based on the updated data included in cell “C2.”

As described above, a user can select multiple cells 302 for which operations associated with AI model 182 are to be performed. Platform 120 may provide prompts associated with the user queries of such cells 302 as inputs to AI model 182 in batches. For example, portion 120 may provide a first portion of the prompts as an input to AI model 182 during a first time period and a second portion of the prompts as an input to the AI model 182 during a second time period.

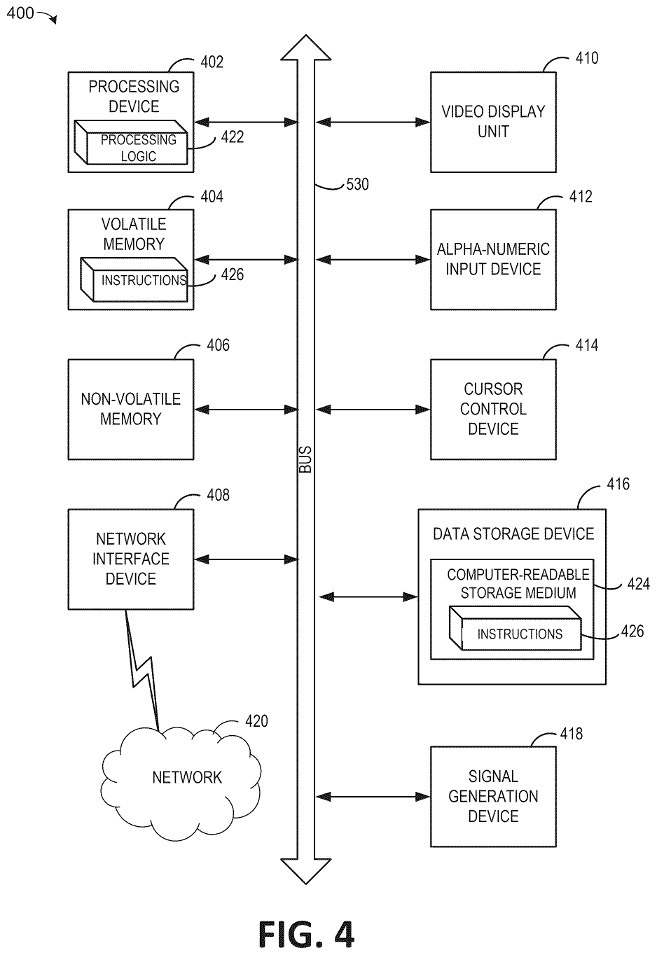

FIG. 4 is a block diagram illustrating an exemplary computer system 400, in accordance with implementations of the present disclosure. The computer system 400 can correspond to platform(s) 120, client devices 102A-N, server machine 150, and/or server machine 180 described herein and with respect to FIGS. 1-3C. Computer system 400 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 428, which communicate with each other via a bus 408.

Processor (processing device) 402 represents one or more general-purpose processing devices such as a microprocessor, central processing unit, or the like. More particularly, processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 and the content generation engine 182 for performing the operations discussed herein.

The computer system 400 can further include a network interface device 422. Computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 420 (e.g., a speaker).

Data storage device 428 can include a non-transitory machine-readable storage medium 424 (also computer-readable storage medium) on which is stored one or more sets of instructions 426 embodying any one or more of the methodologies or functions described herein. The instructions can also reside, completely or at least partially, within main memory 404 and/or within processor 402 during execution thereof by the computer system 400, main memory 404 and processor 402 also constituting machine-readable storage media. The instructions can further be transmitted or received over a network 464 via network interface device 422.

In one implementation, instructions 426 include instructions for operations described above. While computer-readable storage medium 424 is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A system comprising:
a memory; and
a set of one or more processing devices coupled to the memory, wherein the set of one or more processing devices is to:
provide a user of a platform with access to a spreadsheet document via a user interface (UI) of a client device associated with the user, wherein the spreadsheet document comprises a plurality of cells;
receive, based on a user interaction with one or more cells of the plurality of cells, a user query pertaining to an operation associated with an artificial intelligence (AI) model associated with the platform;
update the UI to include the received user query in the one or more cells and one or more UI elements that enable the user to initiate the operation associated with the AI model;
detect a user interaction with the one or more UI elements;
responsive to detecting the user interaction with the one or more UI elements, provide a prompt associated with the user query as an input to the AI model;
obtain one or more outputs of the AI model, wherein the one or more outputs comprise response data pertaining to the user query; and
update the UI to include the response data pertaining to the user query in the one or more cells.

2. The system of claim 1, wherein the set of one or more processing devices is further to:
receive one or more additional user queries pertaining to the operation based on an additional user interaction with one or more additional cells of the plurality of cells of the spreadsheet document, wherein the prompt provided as input to the AI model is further associated with the one or more additional user queries, and the one or more outputs further comprise additional response data pertaining to the one or more additional user queries; and
update the UI to further include the additional response data in the one or more additional cells.

3. The system of claim 1, wherein the set of one or more processing devices is further to:
receive, based on an additional user interaction with one or more additional cells of the plurality of cells, an additional user query pertaining to the operation;
responsive to providing the prompt associated with the user query as an input to the AI model and in view of a batching protocol associated with the platform, provide an additional prompt associated with the additional user query as an additional input to the AI model; and
obtain one or more additional outputs of the AI model, wherein the one or more additional outputs comprise additional response data pertaining to the additional user query, and
wherein the UI is further updated to include the additional response data pertaining to the additional user query in the one or more additional cells.

4. The system of claim 1, wherein the operation comprises at least one of a summarization operation, a data categorization operation, a sentiment analysis operation, a data extraction operation, a data correction operation, a translation operation, or a calculation operation.

5. The system of claim 1, wherein the one or more cells are included in a first column of the spreadsheet document and wherein the user query pertaining to the operation associated with the AI model references an additional cell of the plurality of cells, the additional cell included in a second column of the spreadsheet document, and wherein data of the additional cell is included in the prompt provided as the input to the AI model.

6. The system of claim 5, wherein the set of one or more processing devices is further to:
detect a modification to at least one of the response data pertaining to the user query in the one or more cells or the data of the additional cell;
responsive to detecting the modification, updating the UI to include one or more additional UI elements that signal the detected modification to at least one of the response data pertaining to the user query in the one or more cells or the data of the additional cell.
